(19) United States
(12) Patent Application Publication
(10) Pub. No.: US 2009/0271739 A1
(43) Pub. Date: Oct. 29, 2009

(54) INPUT CONTROL UNIT

(75) Inventors: Tetsuya Nagai, Kanagawa (JP); Koichi Sakai, Kanagawa (JP); Hideo Kawai, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/065,424

(22) PCT Filed: Jul. 20, 2006
(86) PCT No.: PCT/JP2006/314388

§ 371 Date: Feb. 29, 2008

(51) Int. Cl. G06F 3/048

(52) U.S. Cl. 715/835; 715/862; 715/810

(57) ABSTRACT

An input control unit for enabling the user to change the input function of an input key without operating any button is provided.

A display section 15 is provided with a function partition area containing function determination areas and a match detection section 167 generates match detection information indicating that a pointer exists on a predetermined function determination area based on pointer position information indicating the display position of the pointer from a pointer position determination section 161 and function determination area position information indicating the display position of a function determination area from an icon position storage section 163, and sends the generated match detection information to a control section 168. The control section 168 converts the current input function of a numeric key 13a in an input key section 13 in response to the function determination area where the pointer exists based on the match detection information.

### TECHNICAL FIELD

This invention relates to an input control unit used with an information machine such as a computer or a mobile terminal.

### BACKGROUND ART

In recent years, an input unit such as a pointing device has been generally used as means for entering information by simple operation independently of key operation in an information machine such as a computer or a mobile terminal. To use a mobile terminal installing a pointing device of mouse type, light pen type, etc., used formerly, the user needs to hold the mobile terminal in one hand and operate the pointing device in the other; it is difficult to use the mobile terminal because both hands are full.

Then, a recent mobile terminal has been provided with a pointing device of a cross key, a jog dial, a touch pad, etc., to scroll the display and move the display position of a cursor or a pointer so as to allow the user to operate the pointer on a display screen even in a single hand. The user moves the cross key, the touch pad, etc., as required for moving the display pointer to any desired location or any desired position, for example, to an icon displaying an operation target object and presses a button associated with the pointing device, whereby processing of information input, search, edit, transmission and reception, etc., can be performed.

However, in the related art, if more than one execution command operation for an operation target object is required, it is difficult to perform more than one execution command operation only with one pointing device and the operation becomes complicated; this is a problem.

A related art for solving such a problem is described in patent document 1. In this art, a control system detects that a cursor exists in the area of an object of an icon, etc., displayed on a screen continuously for a predetermined time, and displays operation objects representing the descriptions of operation steps for the icon (left click, right click, double click) in the proximity of the icon. Further, if the user positions a pointing device cursor at any of the operation objects and selects the operation object, the control system executes the selected operation object, for example, “double click” for the icon.

Patent document 1: JP-A-2000-242385

### DISCLOSURE OF THE INVENTION

### Problems to be Solved by the Invention

The control system in patent document 1 only displays the descriptions of operation steps at the pointer arrival time at the icon. Therefore, the user can only select any of the displayed operation descriptions and the control system lacks applicability. It is desired that any other operation input section such as a ten-key numeric pad should be utilized more effectively.

It is an object of the invention to provide an input control unit to more simplify and facilitate operation and information entry of an information machine.

### Means for Solving the Problems

The invention provides an input control unit applied to a machine for specifying a predetermined position in a display section by a pointer, the input control unit including a pointer position determination section for generating pointer position information of a display position in the display section of the pointer based on operation information from a first operation input section of the machine; a selection target display specification section for displaying a selection target selected by the pointer on the display section; a match detection section for generating match detection information indicating that the pointer exists on a predetermined selection target based on the pointer position information and selection target position information indicating the display position of the selection target; and a control section for converting the current input function of a second operation input section of the machine in response to the selection target where the pointer exists based on the match detection information.

According to the configuration, the pointer is moved to any selection target, whereby the current input function of a numeric key, etc., can be converted in response to the selection target where the pointer exists.

In the input control unit of the invention, if the selection target is an icon, the control section assigns different functions for performing different operations on the icons to a plurality of suboperation input sections contained in the second operation input section.

According to the configuration, the pointer is placed on any icon, whereby the current input function of the numeric key, etc., can be converted into the function corresponding to the icon.

Further, in the input control unit of the invention, if the selection target is a plurality of function determination areas for determining the input functions of the second operation input section, the selection target display specification section is a function determination area display specification section for displaying the function determination areas on the display section aside from the main area, the match detection section generates match detection information indicating that the pointer exists on a predetermined function determination area based on the pointer position information and function determination area position information indicating the display position of the function determination area, and the control section converts the current input function of the second operation input section into the input function corresponding to the function determination area where the pointer exists based on the match detection information.

According to the configuration, when a plurality of functions are included, the pointer is moved, whereby the current input function of the second operation input section can also be converted into the input function corresponding to each of the functions.

In the input control unit of the invention, the input function is a character input function through the second operation input section and the plurality of function determination areas have different character input modes.

According to the configuration, the pointer is moved, whereby the character input mode in character input can be converted.

The input control unit of the invention has a configuration wherein if the pointer exists within a predetermined distance from an end part of the display section, the control section scrolls a display screen of the display section.

According to the configuration, the pointer is moved, whereby the display screen of the display section can be scrolled.

The input control unit of the invention has a configuration wherein if the pointer exists within a predetermined distance from an end part of the display section and a direction is specified through the second operation input section, the control section scrolls a display screen of the display section in the direction.

According to the configuration, a direction key, etc., of a component of the second operation input section is operated, whereby the display screen of the display section can be scrolled.

The invention also provides a control method of an input control unit applied to a machine for specifying a predetermined position in a display section by a pointer, the control method including the steps of generating pointer position information of a display position in the display section of the pointer based on operation information from a first operation input section of the machine; displaying a selection target selected by the pointer on the display section; generating match detection information indicating that the pointer exists on a predetermined selection target based on the pointer position information and selection target position information indicating the display position of the selection target; and converting the current input function of a second operation input section of the machine in response to the selection target where the pointer exists based on the match detection information.

The invention also provides a program for starting an input control unit applied to a machine for specifying a predetermined position in a display section by a pointer, the program for causing the input control unit to execute the steps of generating pointer position information of a display position in the display section of the pointer based on operation information from a first operation input section of the machine; displaying a selection target selected by the pointer on the display section; generating match detection information indicating that the pointer exists on a predetermined selection target based on the pointer position information and selection target position information indicating the display position of the selection target; and converting the current input function of a second operation input section of the machine in response to the selection target where the pointer exists based on the match detection information.

### Advantages of the Invention

The invention can provide the input control unit having the advantage that it enables the user to change the input function of an input key without operating any button.

### BRIEF DESCRIPTION OF THE DRAWINGS

FIG. 1 is an external view of a mobile telephone installing an input control unit of the invention.

FIG. 2 is an enlarged view of an operation section.

FIG. 3 is a block diagram to show the configuration of the mobile telephone installing the input control unit in an embodiment of the invention.

FIG. 4 is a flowchart to show the operation of the mobile telephone installing the input control unit in the embodiment of the invention.

FIGS. 5 (a), (b) are drawings to show an icon selection example.

FIGS. 6 (a), (b) are drawings to show a mode example of an input key.

FIGS. 7(a), (b) are drawings to show examples wherein the input control unit of the embodiment of the invention is used with a TV broadcast reception terminal and a music player.

FIGS. 8 (a), (b) are drawings to show an example of scrolling a display screen.

FIGS. 9 (a), (b) are drawings to show a scroll example of the display screen.

### DESCRIPTION OF REFERENCE NUMERALS

10 Mobile telephone
11 Lower cabinet
12 Operation section
13 Input key section
14 Upper operation input section
15 Display section
16 Input control unit
17 Upper cabinet
18 Hinge part
161 Pointer position determination section
162 Pointer display specification section
163 Icon position storage section
164 Icon display specification section
165 Function determination area position storage section
166 Function determination area display specification section
167 Match detection section
168 Control section

### BEST MODE FOR CARRYING OUT THE INVENTION

An input control unit of an embodiment of the invention will be discussed with the accompanying drawings.

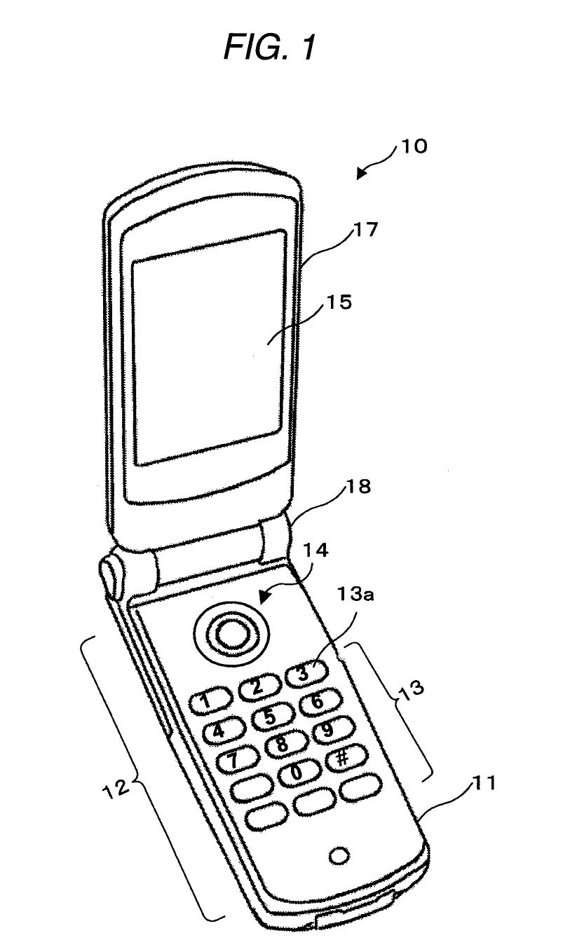

FIG. 1 is an external view of a mobile telephone when the input control unit in the embodiment of the invention is installed in the mobile telephone.

A mobile telephone 10 shown in FIG. 1 is made up of an upper cabinet 17 and a lower cabinet 11 connected so that they can be opened and closed through a hinge part 18. The lower cabinet 11 includes an operation section 12 containing an input key section (lower operation input section) 13 and an upper operation section 14, and the upper cabinet 11 has a display section 15 implemented as a liquid crystal display, etc.

The input key section 13 is formed below the upper operation input section 14 (on the side distant from the hinge part) and is made up of keys (numeric keys) 13a as a plurality of suboperation input sections such as a power key, numeric keys (0 to 9 and alphabetical letters a to z are assigned to the keys), a # key, an * key, and a menu key. The user can press the numeric keys 13a to perform operation of displaying an operation menu on the display section 15 and selecting an item, entering digits and characters, receiving and originating a telephone call and transmitting and receiving mail through an antenna (not shown), and the like including power on and off.

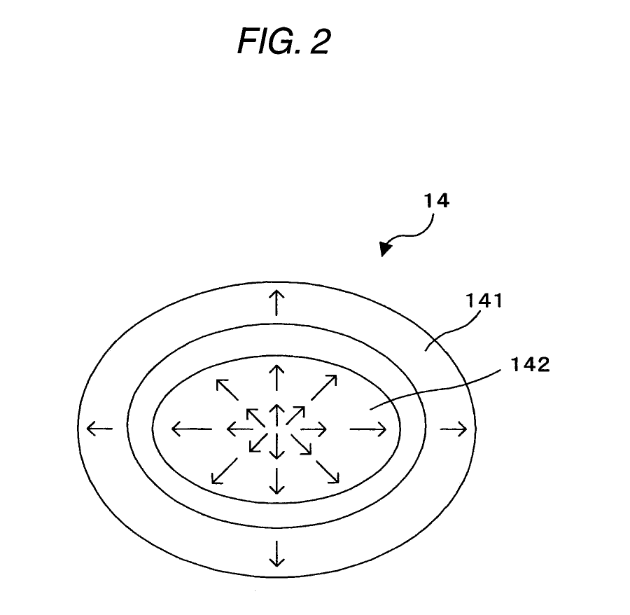

As shown in FIG. 2, the upper operation input section 14 is formed above the input key section 13 (on the side near to the hinge part) and is made up of an annular cross key 141 and a touch pad 142 placed at the center of the cross key 141. The user uses the cross key 141 to move a pointer up and down and from side to side and scroll display and touches the touch pad 142 with a thumb, etc., thereby moving the pointer on the screen 360 degrees as desired (see the arrows in the figure).

In the embodiment, the user moves the pointer on the display section 15 by operating the upper operation input section 14, and the input function of the input key 13 is changed in response to which partition of the display section 15 the pointer exists in.

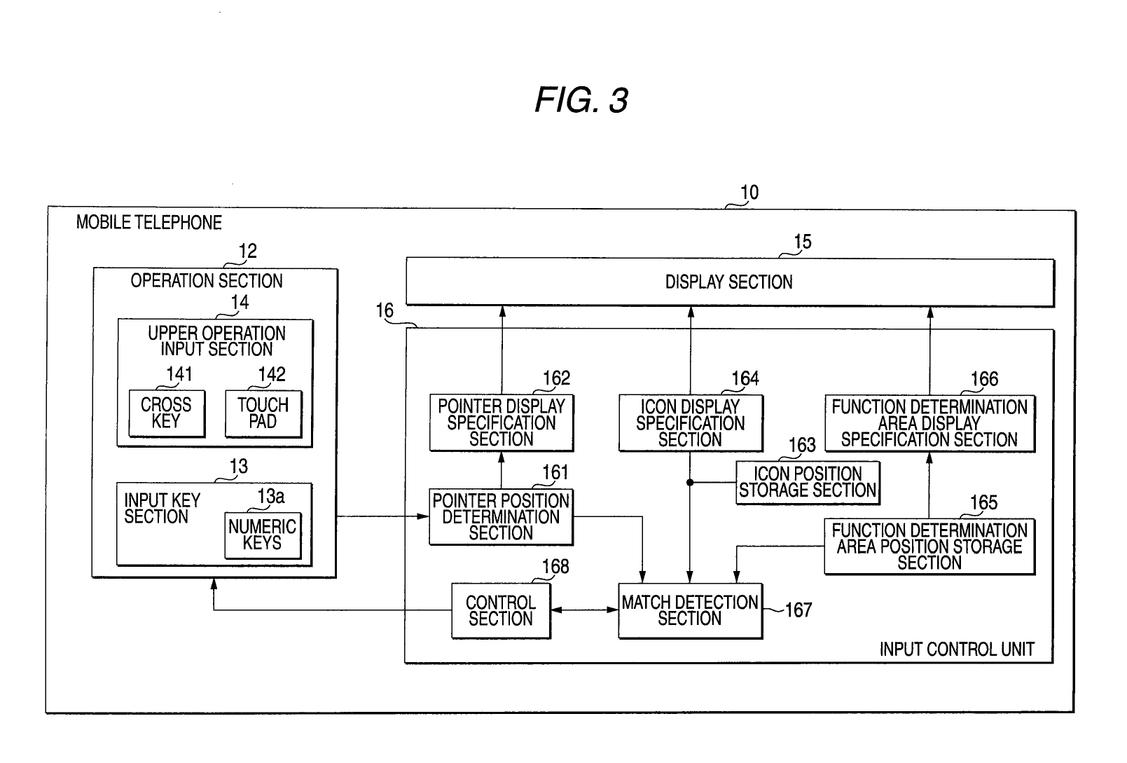

FIG. 3 is a block diagram to show the configuration of the mobile telephone installing the input control unit in the embodiment of the invention.

In FIG. 3, the mobile telephone 10 has the above-described operation section 12 made up of the input key section 13 and the upper operation section 14, the above-described display section 15, and an input control unit 16.

The input control unit 16 has a pointer position determination section 161, a pointer display specification section 162, an icon position storage section 163, an icon display specification section (selection target display specification section) 164, a function determination area position storage section 165, a function determination area display specification section (selection target display specification section) 166, a match detection section 167, and a control section 168.

The pointer position determination section 161 determines the display position of the pointer in the display section 15 based on operation information corresponding to user's pointer operation input to the upper operation section 14, and generates pointer position information (coordinate point on the screen). The pointer display specification section 162 outputs the pointer position information and display information as a pattern of an area containing the pointer shape, color, etc., (information to display the pointer on the screen) to the display section 15, thereby specifying the position to display the pointer on the screen for the display section 15.

The icon position storage section 163 is memory previously storing icon position information of the position in the display section 15 (area-like range) to display the icon of the selection target selected by the pointer. The icon display specification section 164 outputs the icon position information and display information as a pattern of an area containing the icon shape, color, etc., (information to display the icon on the screen) to the display section 15, thereby specifying the position to display the icon on the screen for the display section 15.

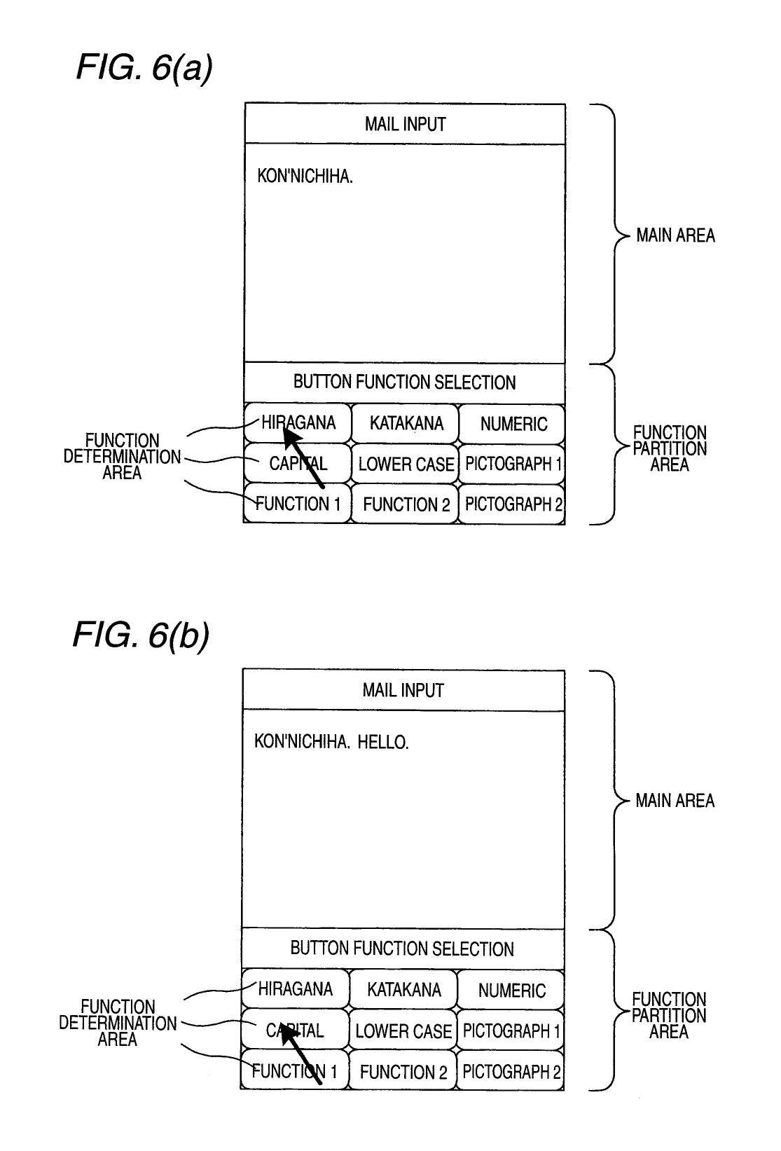

The function determination area position storage section 165 is memory previously storing function determination area position information of the position in the display section 15 (area-like range) to display each of a plurality of function determination areas. The plurality of function determination areas are displayed in a function partition area partitioned aside from a main display area to display the icons on the screen (see FIG. 6). Each of the function determination areas is also a selection target selected by the pointer and when a predetermined function determination area is selected by the pointer, the function of a predetermined key contained in the operation section 12 is changed in response to the selected function determination area.

The function determination area display specification section 166 outputs the function determination area position information and display information as a pattern of an area containing the shape, color, etc., of each function determination area (information to display the function determination areas on the screen) to the display section 15, thereby specifying the positions to display the function determination areas on the screen for the display section 15.

The match detection section 167 generates match detection information indicating that the pointer exists on a predetermined icon or function determination area based on the pointer position information indicating the display position of the pointer and the above-described icon position information or function determination area position information. The control section 168 converts the current input function of the input key 13a in response to the icon or the function determination area in the function partition area where the pointer exists based on the match detection information.

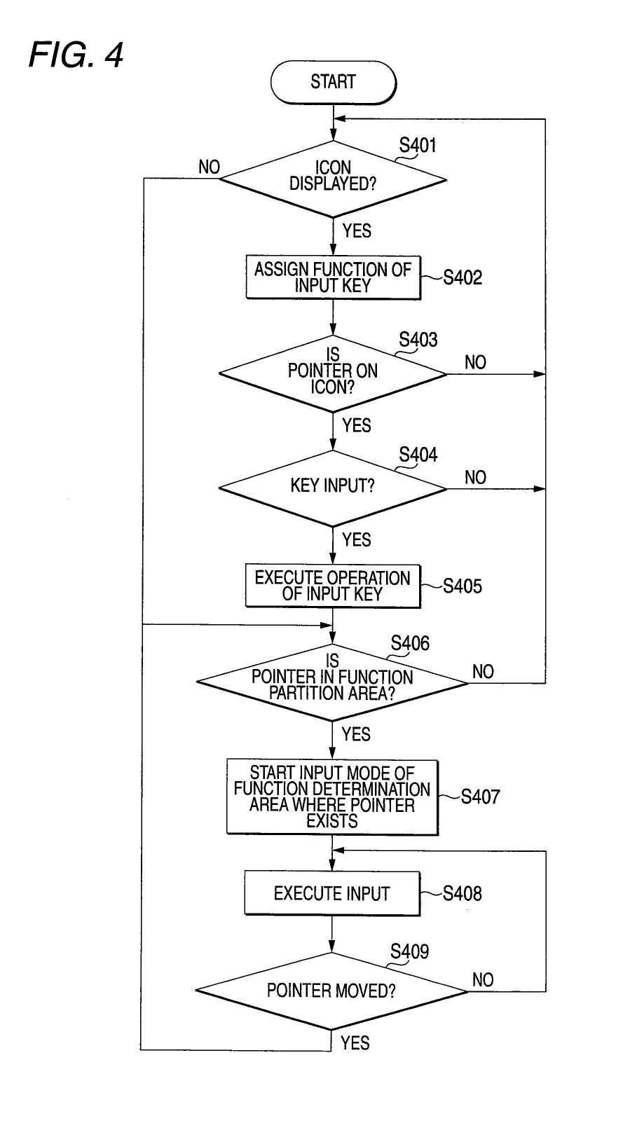

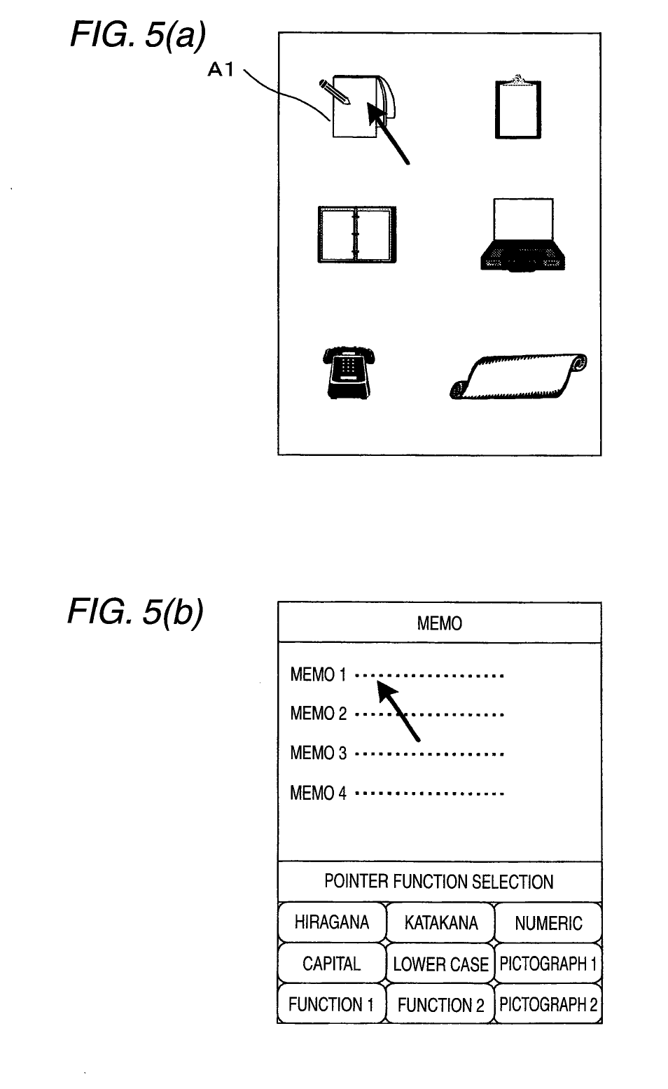

The operation of the described mobile telephone will be discussed with a flowchart of FIG. 4, an icon selection example shown in FIG. 5, and an example of mode change of input key shown in FIG. 6.

First, the control section 168 determines whether or not an icon as a selection target by the pointer is displayed on the display section 15 (step S401). If the control section 168 determines that an icon is displayed on the display section 15, the control section 168 assigns different functions for performing different operations on the icon to the input keys 13a of “1,” etc., in the input key section 13 (step S402). The assignment is made by default stored in memory, etc., not shown. For example, click is assigned to the “1” key in the input key section 13, drag is assigned to “3,” and drop is assigned to the “1” key during dragging (using the touch pad).

Next, the control section 168 determines whether or not the pointer is on the icon (step S403). Here, the match detection section 167 generates match detection information indicating that the pointer exists on the icon based on the pointer position information indicating the display position of the pointer and the icon position information indicating the display position of the icon, and sends the match detection information to the control section 168. The control section 168 determines whether or not the pointer is on the icon based on the presence or absence of the match detection information from the match detection section 167.

FIG. 5 shows a selection example of an icon by the pointer. In FIG. 5, (a) provides an example of an icon displayed on the display section 15. In the display example, for example, if the user moves the pointer to an icon A1 indicating a memo function using the upper operation section 14, the corresponding operation information is sent to the pointer position determination section 161. The pointer position determination section 161 generates pointer position information and sends the pointer position information to the pointer display specification section 162. The pointer display specification section 162 specifies display of the pointer at the position indicated by the pointer position information for the display section 15. The display section 15 displays the pointer at the position.

The match detection section 167 generates match detection information indicating that the pointer exists on the icon A1 of memo based on the pointer position information indicating the display position of the pointer and the icon position information indicating the display position of the icon.

If the control section 168 determines at step S403 that the pointer is on the icon, then the control section 168 determines whether or not any key input is executed (step S404). If the pointer is on the icon as shown in FIG. 5 (a), the “1” key in the input key section 13 shown in FIG. 1 is set to click, the “3” key is set to drag, and the “1” key is set to drop during dragging (using the touch pad), for example. Here, a determination is made as to whether or not any of the keys is input. For example, if the “1” key is input from FIG. 5 (a), the icon is clicked and the substance is opened as in FIG. 5 (b). That is, if the control section 168 determines that any of the keys is input, the control section 168 executes operation of the input key (step S405).

Next, the control section 168 determines whether or not the pointer is in the function partition area (step S406) and if the control section 168 determines that the pointer is in the function partition area, the control section 168 starts the input mode of the function determination area where the pointer exists (step S407). Here, the match detection section 167 generates match detection information indicating that the pointer exists on a predetermined function determination area based on the pointer position information indicating the display position of the pointer from the pointer position determination section 161 and the function determination area position information indicating the display position of the function determination area from the function determination area position storage section 165, and sends the generated match detection information to the control section 168. The control section 168 converts the current input function of the numeric key 13a in the input key section 13 in response to the function determination area where the pointer exists based on the match detection information.

FIG. 6 shows a mode conversion example of an input key. In the example shown in FIG. 6, if the user selects “mail input” by icon selection, the main area of a portion for displaying the input contents of mail and the function partition area of a portion for displaying the function partition are displayed on the display section 15 and the function determination areas corresponding to various input functions are displayed in the function partition area. The function determination areas contain an area corresponding to a “Hiragana” input function and an area corresponding to a “capital” input function in English, for example. When detecting that the pointer is in the portion written as “Hiragana” on the function partition area, the match detection section 167 generates match detection information indicating that the pointer exists on the function determination area corresponding to the portion, and sends the match detection information to the control section 168. The control section 168 starts the input mode of “Hiragana” based on the match detection information.

Subsequently, the user enters the mail contents using the numeric keys 13a (step S408). Since the input mode of “Hiragana” is started, when the user enters the mail contents using the input keys 13, the mail contents are displayed in “Hiragana.” In the example in FIG. 6, the description of “Kon′nichiha” is entered by the user in a state in which the input mode of “Hiragana” is started.

Subsequently, the control section 168 determines whether or not the pointer moves based on the match detection information from the match detection section 167 (step S409). If the control section 168 does not determine that the pointer moves, the control section 168 returns to step S408 and maintains the input in the same mode. In the example in FIG. 6 (a), the user continues to enter the mail contents in the “Hiragana” input mode.

On the other hand, if the control section 168 determines at step S409 that the pointer moves, the control section 168 returns to step S406 and determines whether or not the pointer is on the function partition area based on the match detection information. In the example shown in FIG. 6 (b), the pointer is moved to the portion written as “capital” on the function partition area and thus the control section 168 starts the input mode of the function determination area where the pointer exists, namely, the input mode of “capital” (step S407). At this time, if the user enters the mail contents using the numeric keys 13a, the contents indicated in “capital” in English are input. The description of “HELLO” in FIG. 6 (b) is the description input in the input mode of “capital.” That is, if the pointer is moved from “Hiragana” of a segment (function determination area) in the function partition area to the “capital” portion, the input mode changes from Hiragana to English capital.

If the control section 168 does not determine at step S401 that an icon is displayed on the display section 15, the control section 168 goes to step S406 and determines whether or not the pointer is on the function partition area.

If the control section 168 does not determine at step S403 that the pointer is on the icon, at step S404 that any of the keys is input, or at step S406 that the pointer is in the function partition area, the control section 168 returns to step S401 and again determines whether or not an icon is displayed.

As described above, the match detection section 167 generates the match detection information indicating that the pointer exists on a predetermined icon or function determination area based on the pointer position information indicating the display position of the pointer and the icon position information indicating the display position of the icon or the function determination area position information indicating the display position of the function determination area, and sends the match detection information to the control section 168. The control section 168 converts the current input function of the input key section 13a in response to the function determination area where the pointer exists based on the match detection information.

Thus, when the user wants to change the function of any input key, the user can change the input function of the input key without operating any button.

Although the mail input example has been described, the invention can also be applied to transmission and reception of TV broadcast, a music player, etc.

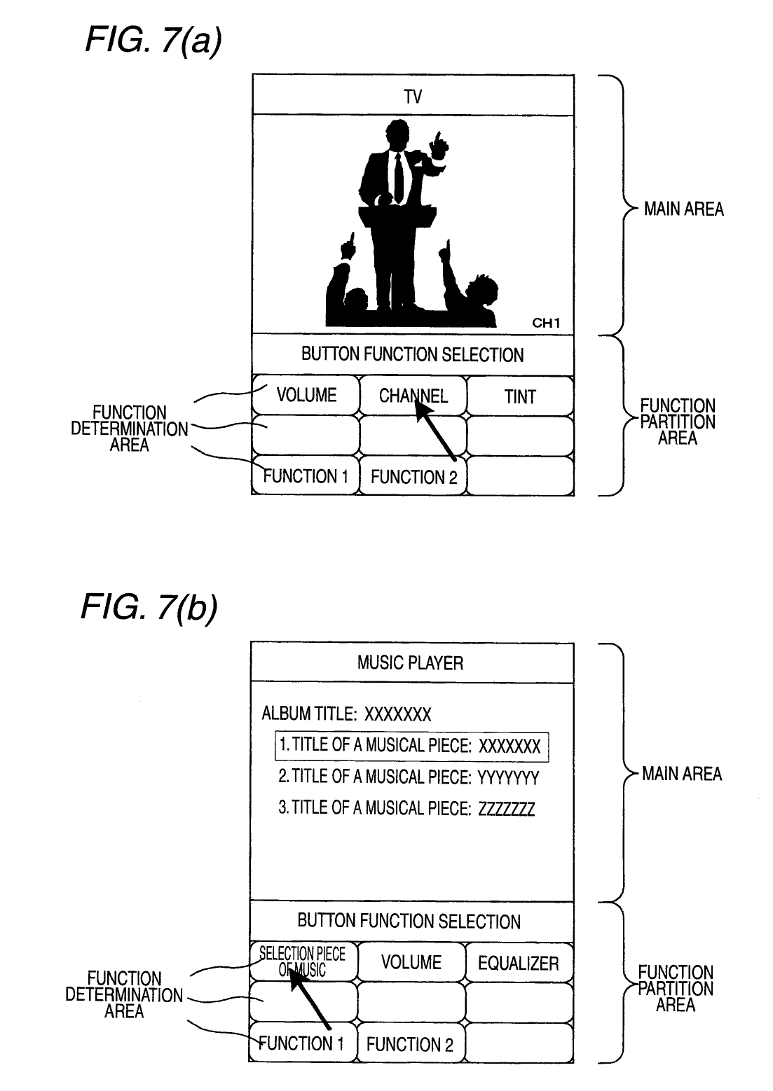

FIG. 7 shows examples of applying the input control unit of the invention to a TV broadcast reception terminal and a music player. FIG. 7 (a) shows an example wherein a TV broadcast reception terminal is provided with a function partition area below a main area for displaying the reception content of TV broadcast and function determination areas are displayed in the function partition area. When the user wants to change the function of an input key, for example, when the user wants to change a key to the channel input mode, the user moves the pointer to the portion written as “channel” (function determination area) and the control section 168 converts the current input function of the numeric key 13a in the input key section 13 in response to the function determination area where the pointer exists, namely, “channel” change.

FIG. 7 (b) shows an example wherein the display section 15 of a music player is provided with a function partition area and function determination areas are displayed in the function partition area. When the user wants to change the function of an input key, for example, when the user wants to select a piece of music, the user moves the pointer to the portion written as “selection piece of music” (function determination area) and the control section 168 converts the current input function of the numeric key 13a in the input key section 13 in response to the function determination area where the pointer exists, namely, “selection piece of music” change. The title of a musical piece corresponding to each key is also displayed at the same time as the current input function of the input key section 13 is changed. The user can select any piece of music by pressing the numeric key 13a in the input key section 13 while seeing the display section 15.

If the pointer exists within a predetermined distance from an end part of the display section 15, the control section 168 may perform processing of scrolling a display screen of the display section 15.

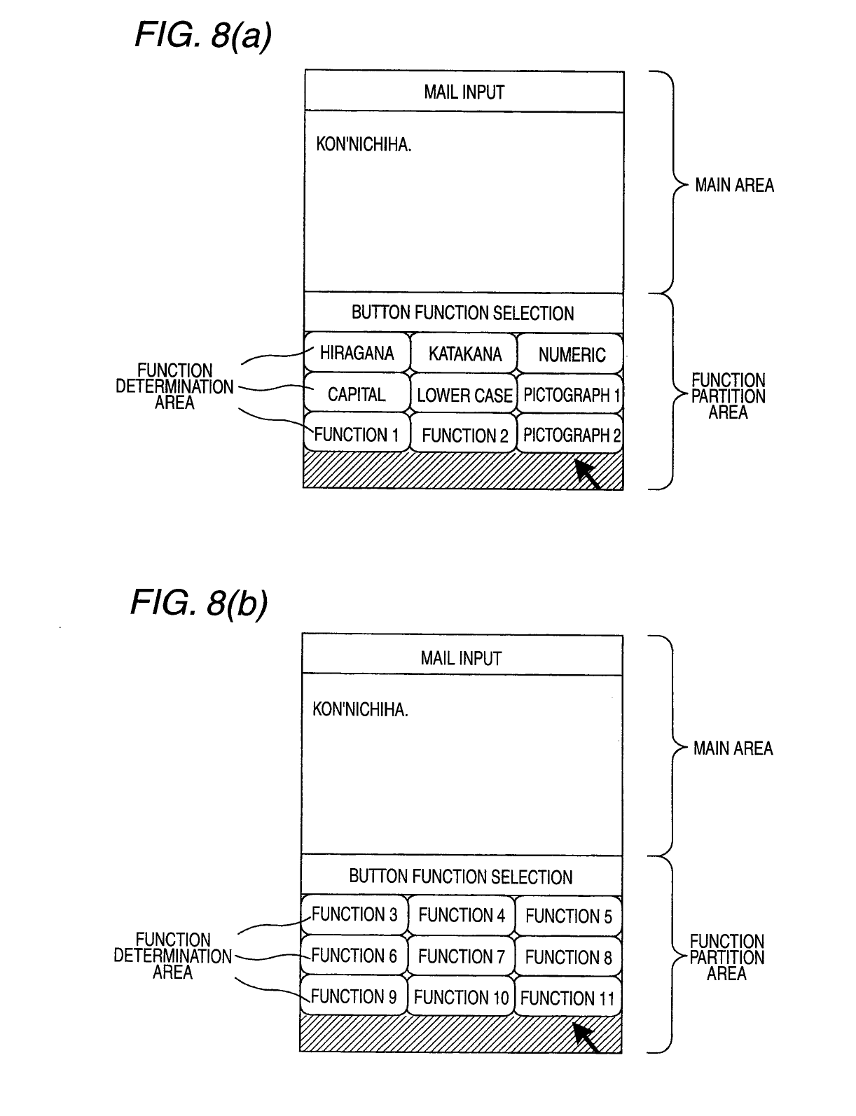

FIG. 8 is an example wherein the control section 168 scrolls the display screen of the function partition area. FIG. 8 (a) provides a display screen example when mail is input at a predetermined point in time, and (b) provides a screen example after the display screen of the function partition area is scrolled from the screen in (a).

When the screen shown in FIG. 8 (a) is displayed, if the user moves the pointer within a predetermined distance from an end part of the display section 15 by operating the upper operation section 14, the match detection section 167 generates the match detection information indicating that the pointer exists at a predetermined position in the function partition area (hatched part in FIG. 8) based on the pointer position information indicating the display position of the pointer and the function determination area position information indicating the display position of the function determination area, and sends the match detection information to the control section 168. The control section 168 automatically scrolls the display screen of the function partition area in the display section 15 based on the match detection information. Such processing enables the user to easily assign a larger number of functions to the input keys. Only if the user specifies a direction by operating the cross key 141, etc., in the state in FIG. 8 (a), the control section 168 may scroll the function partition area in the direction.

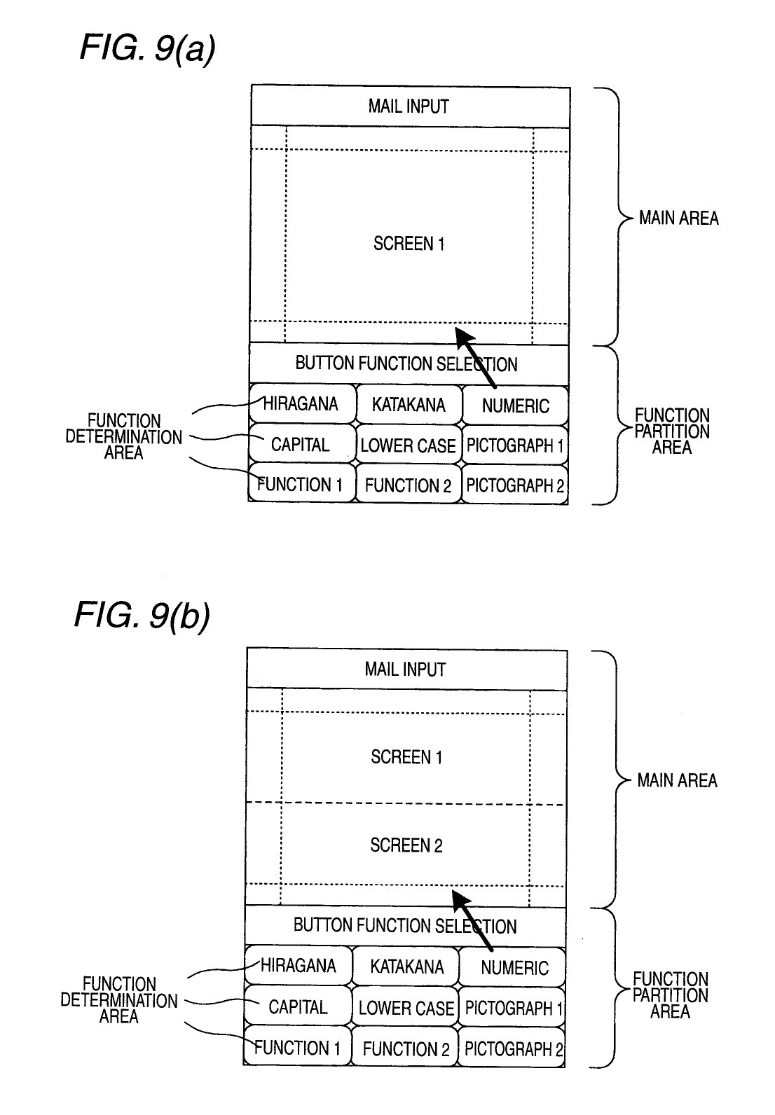

FIG. 9 shows a scroll example of the display screen of the main area. FIG. 9 (a) shows the former display screen and when the screen is displayed, the pointer is moved from the screen end within a predetermined distance (to the dotted line) and thus the control section 168 automatically scrolls the display screen a predetermined amount. FIG. 9 (b) shows an example of scrolling the display screen by a longitudinal half amount of the main area from FIG. 9 (a); the lower half of screen 1 is displayed and the upper half of screen 2, the next screen is displayed.

Also in the example, only if the user specifies a direction by operating the cross key 141, etc., in the state in FIG. 9 (a), the control section 168 may scroll the main area in the direction. For example, if the pointer is within a predetermined distance from a longitudinal screen end (up to upper and lower dotted lines), for example, the “3” key can be set to an up scroll key and the “9” key can be set to a down scroll key. Likewise, if the pointer is within a predetermined distance from a lateral screen end (up to left and right dotted lines), the “1” key can be set to a left scroll key and the “3” key can be set to a right scroll key.

When detecting that the pointer exists on an icon, the input control unit of the invention can assign different functions for performing different operations on the icon on which the pointer exists to the keys. Therefore, the user can change the input function of the input key without operating any button and a mouse, etc., also becomes unnecessary and simplifying the configuration and reduction of operation can be realized.

Further, when the input control unit of the invention gives a command of providing the function partition area to the display section and detects the position at which the pointer exists on the function partition area, the input control unit converts the current input function of the input key or the display screen in response to the function determination area where the pointer exists, whereby the user can change the input function of the input key without operating any button and a mouse, etc., also becomes unnecessary and simplifying the configuration and reduction of operation can be realized.

The invention also provides a program for causing the input control unit to execute the procedure as shown in FIG. 4. The program is retained in a memory area provided in the control section 168 or storage in the input control unit 16, the mobile telephone 10 and causes the input control unit 16 to execute a predetermined procedure.

In the embodiment, the input control unit of the invention is applied to a mobile telephone having at least two operation input sections of a first operation input section for determining the pointer position and a second operation input section with a function converted in response to the selection target (icon or function determination area) selected by the pointer. In the embodiment described above, the two operation input sections are made up of the upper operation input section (cross key and touch pad) and the input key section (numeric keys), but application of the input control unit of the invention is not limited to such an operation mode.

The mobile terminal incorporating the input control unit is not limited to a mobile telephone and also contains any other mobile machine such as a PDA (Personal Digital Assistant). Further, the machine incorporating the input control unit is not limited to a mobile machine and the input control unit can also be applied to a desktop machine.

While the embodiments of the invention have been described, it is to be understood that the invention is not limited to the items shown in the embodiments and the invention is also intended for those skilled in the art to make modifications and application based on the description of the invention and well-known arts and the modifications and the application are contained in the scope to seek protection.

### INDUSTRIAL APPLICABILITY

As described above, the input control unit according to the invention has the advantage that it enables the user to change the input function of the input operation section without operating any button, and is useful as an input control unit, etc., to more facilitate operation and information entry of a mobile terminal.

1-10. (canceled)

11. An input control unit applied to a machine for specifying a predetermined position in a display section by a pointer, said input control unit, comprising:
a pointer position determination section for generating pointer position information of a display position in the display section of the pointer based on operation information from a first operation input section of the machine;
a selection target display specification section for displaying a selection target selected by the pointer on the display section;
a match detection section for generating match detection information indicating that the pointer exists on a predetermined selection target based on the pointer position information and selection target position information indicating the display position of the selection target; and
a control section for converting the current input function of a second operation input section of the machine in response to the selection target where the pointer exists based on the match detection information.

12. The input control unit as claimed in claim 11 wherein
the selection target is an icon and said control section assigns different functions for performing different operations on the icons to a plurality of suboperation input sections contained in the second operation input section.

13. The input control unit as claimed in claim 11 wherein
the selection target is a plurality of function determination areas for determining the input functions of the second operation input section and said selection target display specification section is a function determination area display specification section for displaying the function determination areas on the display section aside from the main area, wherein
said match detection section generates match detection information indicating that the pointer exists on a predetermined function determination area based on the pointer position information and function determination area position information indicating the display position of the function determination area, and wherein
said control section converts the current input function of the second operation input section into the input function corresponding to the function determination area where the pointer exists based on the match detection information.

14. The input control unit as claimed in claim 13 wherein
the input function is a character input function through the second operation input section and the plurality of function determination areas have different character input modes.

15. The input control unit as claimed in claim 11 wherein
if the pointer exists within a predetermined distance from an end part of the display section, said control section scrolls a display screen of the display section.

16. The input control unit as claimed in claim 11 wherein
if the pointer exists within a predetermined distance from an end part of the display section and a direction is specified through the second operation input section, said control section scrolls a display screen of the display section in the direction.

17. A machine including an input control unit as claimed in claim 11, the above-mentioned display section, and the above-mentioned first and second operation input sections.

18. A mobile terminal implemented as the machine as claimed in claim 17.

19. A control method of an input control unit applied to a machine for specifying a predetermined position in a display section by a pointer, said control method comprising the steps of:
generating pointer position information of a display position in the display section of the pointer based on operation information from a first operation input section of the machine;
displaying a selection target selected by the pointer on the display section;
generating match detection information indicating that the pointer exists on a predetermined selection target based on the pointer position information and selection target position information indicating the display position of the selection target; and
converting the current input function of a second operation input section of the machine in response to the selection target where the pointer exists based on the match detection information.

20. A computer program product embodied on a computer readable medium and for starting an input control unit applied to a machine for specifying a predetermined position in a display section by a pointer which, when executed by the input control unit, cause said input control unit to execute the steps of:
generating pointer position information of a display position in the display section of the pointer based on operation information from a first operation input section of the machine;
displaying a selection target selected by the pointer on the display section;
generating match detection information indicating that the pointer exists on a predetermined selection target based on the pointer position information and selection target position information indicating the display position of the selection target; and
converting the current input function of a second operation input section of the machine in response to the selection target where the pointer exists based on the match detection information.
